(19) United States
(12) Patent Application Publication
(10) Pub. No.: US 2022/0400143 A1
(43) Pub. Date: Dec. 15, 2022

(54) REAL-TIME VISUALIZATION MODULE AND METHOD FOR PROVIDING THE SAME

(71) Applicant: Javid Vahid, Dana Point, CA (US)

(72) Inventor: Javid Vahid, Dana Point, CA (US)

(21) Appl. No.: 17/806,671

(22) Filed: Jun. 13, 2022

Related U.S. Application Data
(60) Provisional application No. 63/209,726, filed on Jun. 11, 2021.

(51) Int. Cl. H04L 65/401; H04L 65/403; H04L 67/133; H04N 7/15; H04N 7/14

(52) U.S. Cl. CPC H04L 65/4015; H04L 65/403; H04L 67/133; H04N 7/155; H04N 7/141

(57) ABSTRACT

A real-time visualization module comprising a database and a set of software components programmed to enable the real-time visualization module to operate concurrently with a video conferencing module, provide an application programming interface to a user that enables the user to upload and organize content to the database, deliver content from the database to users in real-time, wherein said content is displayed by the video conferencing module, and configure a server to display through the video conferencing module the manipulations made to the content in real-time. By providing a real-time visualization module, a presentation host may easily share content uploaded to said database for active content sharing without sharing their desktop, thus ensuring only pertinent content is shared with participants. Additionally, content may be shared with participants in a way that allows them to actively influence or manipulate the content presented to other participants or independently from other participants.

### CROSS-REFERENCE TO RELATED APPLICATIONS

This application claims the benefit of U.S. Provisional Application No. 63/209,726 filed Jun. 11, 2021, which is hereby incorporated by reference, to the extent that it is not conflicting with the present application.

### FIELD OF THE INVENTION

The invention relates generally to visualization modules and more specifically to a real-time visualization modules which can operate concurrently with a video conferencing module.

### DESCRIPTION OF THE RELATED ART

Over the past year, the COVID-19 pandemic has pushed virtual communication to the forefront in nearly every field. Reliance on existing video conferencing modules (VCM), such as Zoom or Microsoft Teams have illustrated the lack effective method facilitate virtual engagement. Particularly with respect to education, online learning does not yet allow students to engage in lessons the same way they would be able to in a physical classroom.

In existing VCMs, a video conference host (“host user”), such as a teacher, must share their computer screen with the other participants (“participant users”), such as students, in order to share content. Screen sharing is limiting because it easy for a host to mistakenly share sensitive information, participants often have difficulty seeing the content clearly due to lag, and it does not allow the participants to control and manipulate shared content.

Additionally, screen sharing is limited in the types of content that can be shared. For example, there is not currently a way for a host to share interactive content, such as 3D models, with other participants.

Therefore, there is a need to provide a real time visualization module to facilitate virtual engagement in education and business sectors.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

The disclosed real-time visualization module provides users with an improved method to share content within or agnostically alongside a video conferencing module (VCM), wherein content may be. but is not limited to, word documents, interactive documents, 3D models, etc. The real-time visualization module may be a set of software components which allow users to share and manipulate content in real-time within a VCM, without screen sharing. For example, utilizing the real-time visualization module, a user may share a 3D model within a VCM, manipulate the 3D model via rotation, zooming, exploding the view, etc., and those manipulations will be displayed on other users VCM screens in real time. In alternative embodiments, the users may be able to independently manipulate the 3D model without influencing other users' screens.

As an example, a method for providing a real-time visualization in the context of a video conference may comprising the steps of providing a video conferencing module; providing a real-time visualization module; providing an application programming interface; providing a database server for storing and processing content necessary to conduct the video conference; allowing users to utilize the application programming interface to upload content to the database server; allowing the users to utilize the application programming interface to share content stored on the database server with other users attending the video conference; and configuring the real-time visualization module to coordinate with the database server to display through the video conferencing module the manipulations made to the content in real time.

Another exemplary method for providing a real-time visualization module may be providing a real-time visualization module which operates concurrently with an existing VCM, providing a database server, and configuring the real-time visualization module and database server to display content within the video conferencing module in real-time.

A real-time visualization module comprising a set of software components may be provided. As an example, the software components may be an integrating software component, application programming interface software component, and a live software component.

The integrating software component may be configured to enable the real-time visualization module to operate concurrently with the video conferencing module.

The application programming interface software component may provide users with a database server. Additionally, the application programming interface software component may provide users with an interface to upload and organize content to the database server. An advantage of utilizing a database server to receive and host shareable files is that the latency associated with interacting with database server hosted shareable files may be lesser than the latency associated with interfacing directly with participant hosted shareable files, thus improving presentation quality. Providing files from a database server may also allow each participant at a meeting to easily access and manipulate a database server hosted file without influencing the meeting host's bandwidth.

The live software component may configure the database server to deliver content to users in real-time within the video conferencing module. Additionally, the live software component may configure the database server to display content manipulations in real-time within the video conferencing module.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1 illustrates an exemplary real-time visualization module operating concurrently with a video conferencing module, according to an aspect.

FIG. 2 illustrates an exemplary application programming interface (API) for a visualization module, according to an aspect.

FIGS. 3A-3B illustrate an exemplary functionality of disclosed real-time visualization module, according to an aspect.

FIG. 4 illustrates an exemplary host sharing content with participants, according to an aspect.

FIG. 5 illustrates an exemplary host sharing a 3D model with participants through the disclosed real time visualization module, according to an aspect.

FIG. 6 illustrates the process flow diagram for an operator providing users with a real time visualization module, according to an aspect.

FIG. 7 illustrates the process flow diagram for a host user utilizing the real time visualization module to share content, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

It should be understood that, for clarity of the drawings and of the specification, some or all details about some structural components or steps that are known in the art are not shown or described if they are not necessary for the invention to be understood by one of ordinary skills in the art.

For the following description, it can be assumed that most correspondingly labeled elements across the figures (e.g., 111 and 311, etc.) possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

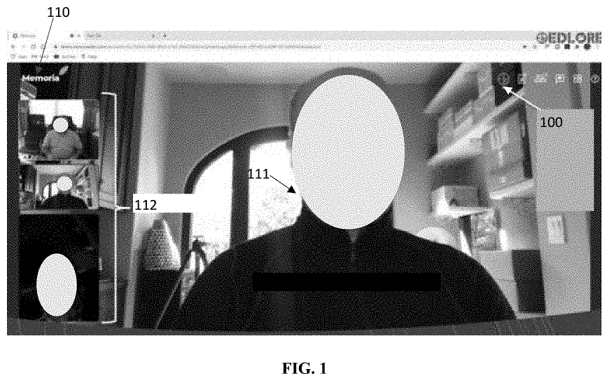

FIG. 1 illustrates an exemplary real-time visualization module (visualization module, EdLore module, EdLore) 100 operating concurrently with a video conferencing module 110, according to an aspect. The video conferencing module 110 may be a video conferencing application such as Zoom, Microsoft Teams, Skype, or Memoria. In existing VCMs, a video conference host (host) 111 must share their computer screen with the other participants 112 in order to share content, wherein the content may be an interactive word document, a 3D model, etc. Screen sharing natively through these VCMs may be limiting because it is easy for a host 111 to mistakenly share sensitive information, participants 112 may struggle to see the content clearly due to lag (e.g., high latency), and participants are not able to control and manipulate shared contents. The disclosed real time visualization module 100, also referred to as EdLore, supplies users, both hosts 111 and participants 112, with a superior method for content sharing via a real-time visualization.

EdLore 100 may be a set of software components which allow users to share and manipulate content in real-time within (or alongside) a VCM 110, without utilizing the VCMs native screen sharing capabilities. As such, EdLore 100 may provide may be configured to enable real-time visualization in the context of a video conference. It should be understood that the EdLore 100 software components may be configured in a plurality of ways to operate concurrently with the VCM 110. In one embodiment, EdLore 100 may be configured as a plug-in for the VCM 110. In another embodiment, EdLore 100 may be configured as an extension for the VCM 110. In yet another embodiment, the EdLore 100 software components may be configured as a software development kit (SDK) for any VCM 110. It should be understood that alternate embodiments are possible. It should also be understood that EdLore 100 may be configured to operate concurrently with the VCM 110 in a web browser or in a desktop application.

As an example, the software components of EdLore 100 may include, but are not limited to, an integrating software component, API software component, and real-time software component. The integrating software component may be a software component which enables EdLore 100 to operate concurrently with a VCM 110. In other words, the integrating software component enables EdLore 100 to operate at the same time as the VCM 110 and utilize the VCM 110 to share content in real-time. It should be understood that the integrating component may be configured such that the EdLore module 100 functionalities are compatible with each potential VCM.

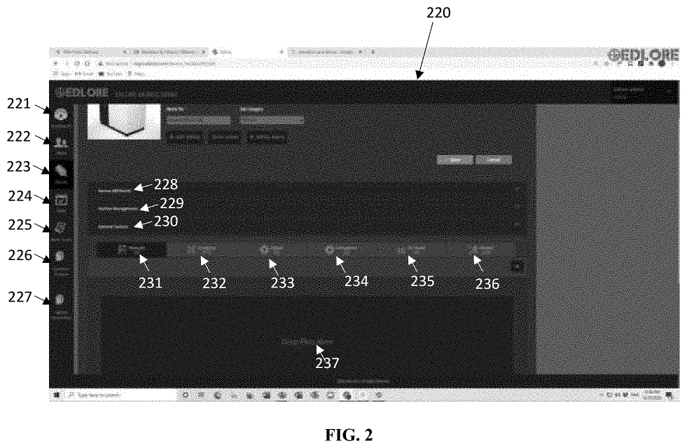

The API software component may be a software component which provides with a database server for content storage as well as an interface through which users can easily upload content to the database server. An exemplary application software interface (API) 220 is illustrated in FIG. 2.

The real-time (live) software component may be a software component which provides users with the ability to share and manipulate content in real-time within the VCM 110. In other words, the live software component may display content, which is stored in the database server, on each user's VCM 110 screen. Then, as a user manipulates the content, and the manipulations may be displayed on every user's screen.

As an example, EdLore 100 may be ideal for improving engagement in online educational courses. For these online educational courses, the host 111 may be a teacher and the participants 112 may be students. Utilizing EdLore 100, a teacher can upload course content to the database server and share said content in real-time within the VCM 110 that is utilized for class meetings. Exemplary course content may be a 3D model, wherein the 3D model can be manipulated by rotating, zooming, taking a cross section, exploding to view internal parts, etc. Among other possibilities, course content may also be an interactive word document. For example, the interactive word document may be a document detailing the purpose and operation of the 3D model with links to additional information about the 3D model, such as parts, videos, etc.

As disclosed above, as the teacher shares course content with their students, EdLore can enable the teacher to manipulate the course content within the VCM 110. Additionally, the teacher can give control (“transfer manipulation control”) to a student and allow the student to manipulate the shared course content, such that the student's manipulations are reflected on all students' screens. It should be understood that it is also possible for a teacher to give control of course content to all students, such that each student can manipulate and explore course content individually, i.e., without the manipulations being reflected on other students VCM 110 screens. These functionalities may be extended beyond a classroom environment, to staff meetings, virtual medical appointments, etc. It should be understood that the while the shared content (and manipulations made to the shared content) in certain embodiments may be made visible through the VCM 110, the real-time visualization module 100 may not necessarily be housed within the VCM 110 and said real-time visualization module 100 may be agnostic in relation to the VCM 110. As such, users of the real-time visualization module 100 may be able to share and view files without the requirement of using a VCM simultaneously, and the real-time visualization module may run outside of and independently from the VCM.

FIG. 2 illustrates an exemplary application programming interface (API) 220 for an EdLore module, according to an aspect. As an example, the EdLore API 220 may be equipped with a drag and drop feature 237 for users to easily upload content to the database server. It should be understood that the term “database”, “database server”, etc. may refer to the required storage and processing resources to facilitate the storage and manipulation of content uploaded within the EdLore module (e.g., cloud) as needed. Manipulation of certain types uploaded content, such as 3D models may require processing resources either provided by said database server, or potentially the participant's device.

In an exemplary embodiment, organization options for the disclosed EdLore API 220 may include: dashboard 221, users 222, devices 223, tasks 224, mark order 225, operations manuals 226, universal documents 227, device 228, section management 229, general section 230, manuals 231, drawings 232, videos 233, animations 234, 3D model 235, and wizard 236. The shown organization options may be ideal for an instructor to organize and upload course content or configure the real-time visualization module setting, for example.

In an embodiment, the API 220 itself may be utilized in order to schedule or set up a meeting. The API may have suitable options, such as those described hereinabove, that allows a user to choose a target VCM type during their setup of a meeting. In such an embodiment, the EdLore module may operate agnostically with relation to the VCM, such that the user may select their preferred VCM, while still allowing the EdLore module to operate alongside it. It should be understood that the term “agnostic” in this application refers to the real-time visualization module operating independently of any particular VCM, thus allowing said real-time visualization module to be used with any suitable VCM. A VCM selection option may include a drop-down menu listing out potential VCMs for the users to utilize alongside the EdLore module. The user may then select a preferred VCM from said drop-down menu and the VCM application would open and allow the user to schedule or attend a meeting. In an alternative embodiment, the scheduling of meetings may be handles directly through the real-time visualization module and pushed through to the corresponding VCM as needed.

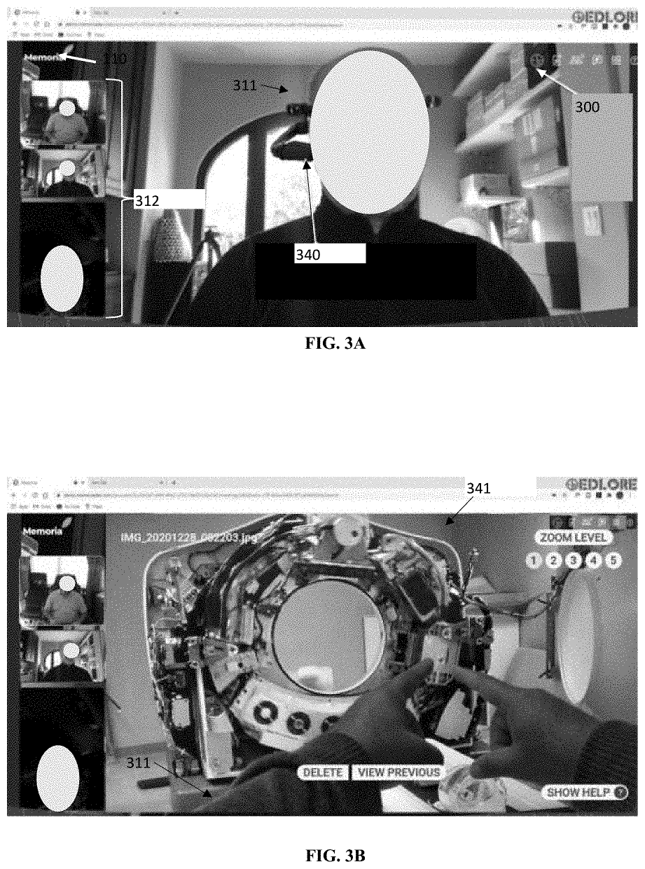

FIGS. 3A-3B illustrate an exemplary functionality of real-time visualization module 300, according to an aspect. In addition to enabling users to share content in real-time, EdLore 300 can also be configured to share a live video input from a corresponding physical device within a VCM 310. For example, an instructor could pair an external recording device, such as a wearable camera 340, through the API 220 devices tab 223, as seen in FIG. 2. During an online class session, the instructor can share the live input from the wearable camera 340, as shown in FIG. 3B. The live video input may be used to display shared content 341, such as the disclosed live video feed illustrated in FIG. 3B. Such a set-up is advantageous because a wearable camera 340 allows an instructor to show students exactly what they are seeing and doing, thus improving online engagement. It should be understood that other devices, such as meters, oscilloscopes, smart boards, etc., or another external device, can also be paired to EdLore 300 to enable their functionality within the EdLore operation system.

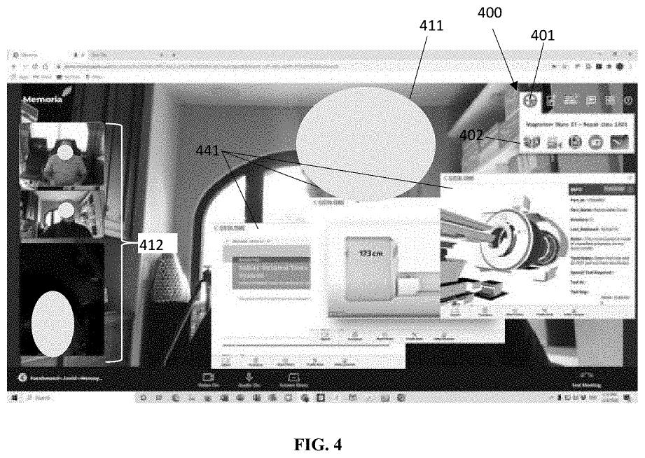

FIG. 4 illustrates an exemplary host 411 sharing content 441 with participants 412, according to an aspect. As an example, hosts 411 may click on the EdLore logo (“logo”, “logo icon”, real-time visualization module icon”) 401 within the VCM 410, then select which content to share via a drop-down menu 402. As disclosed hereinabove, the interface for engaging with the real-time visualization module 400 may be a logo icon 401 integrated in or on any VCM. Interacting with the logo icon 401 of this real-time module 400 may provide a drop-down menu 402 to a host during a presentation to allow them to open multiple windows, such that each of these windows is automatically made visible to each participant at said presentation without needing to share the host's screen or application. Furthermore, the host may display a 3D model and have their manipulations to the 3D model be reflected on the participant's screens. The host may also elect to transfer control to a selected participant, who may manipulate the 3D model to have their manipulations be reflected on the other participants (and hosts) screens.

It should be understood that the disclosed real time visualization module 400 may, in certain embodiments, be utilized as a plugin within an existing video conference module, such as Zoom, vice versa, etc. Through the implementation of the real time visualization module within (or agnostically alongside) an existing video conference module, the various capabilities and advantages provided by the real time visualization module may be afforded to any compatible video conference module.

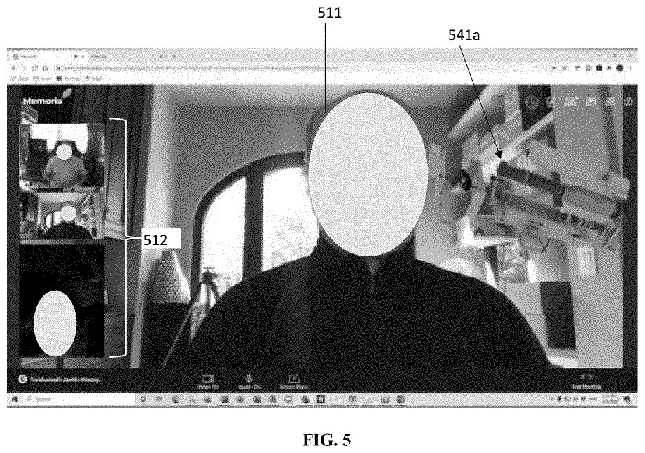

FIG. 5 illustrates an exemplary host 511 sharing a 3D model 541a with participants 512 through the disclosed real time visualization module, according to an aspect. As shown by FIG. 5, a host 511 may share content 541a with other participants 512. In the disclosed embodiment, the shared content is a 3D model 541a. As described previously, the manipulations made to the 3D model by the host may be reflected on each participant's screen. The host may selectively transfer control of the 3D model 541a to a specific participant to allow them to manipulate the 3D object 541a and have these manipulations be performed on each other participant's screens. The host may also allow each participant to freely manipulate the 3D model 541a without influencing and other participant's view of the 3D model.

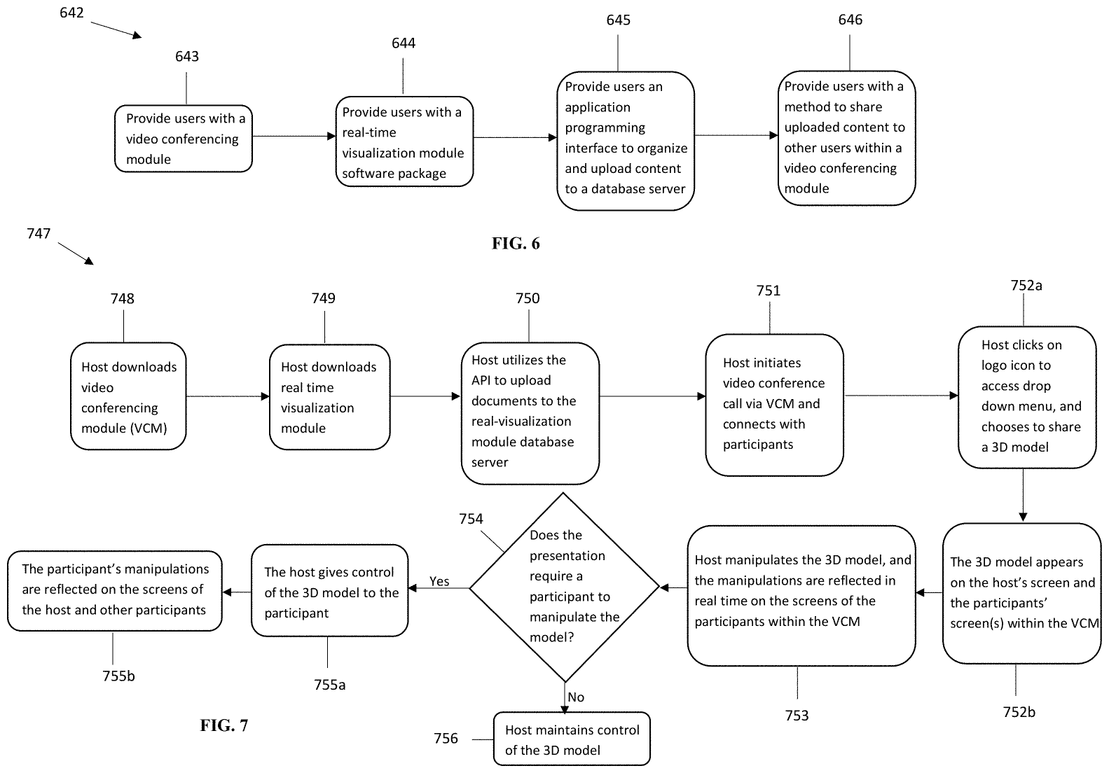

FIG. 6 illustrates the process flow diagram for an operator providing users with a real time visualization module 642, according to an aspect. In order to provide the herein disclosed real-time visualization module to user, an operator must provide the necessary modules and systems for a user to access. In an embodiment, the hereinbelow steps may be utilized by an operator in order to provide users with the disclosed real-time visualization module. First the operator may provide users with a video conferencing module 643. Next, the operator may provide the users with a real-time visualization module software package 644. Then, the operator may provide user with an application programming interface (“API”) to organize and upload content to a database server 645. Upon providing the users with the API, the operator may finally provide users with a method to share uploaded content with other users within said video conferencing module 646. As described hereinabove, the database server may be responsible for both storing and processing the content required for a presentation. As such, the real-time visualization module is configured to coordinate with the database server to display, through the video conferencing module, the manipulations made to the content in real time. The process through which users are able to share said content with other users may require the user to click on the real-time visualization module logo, such as logo icon 401 of FIG. 4, to produce a drop-down menu 402, and then using said drop-down menu to selectively pick which content to share. Obvious modifications to the provided steps, such as skipping the step in which the operator provides the video conference module to user if the users already have the proper video conference module, may be implemented where practical or necessary.

FIG. 7 illustrates the process flow diagram for a host user utilizing the real-time visualization module to share content 747, according to an aspect. The herein disclosed process flow diagram 747 of FIG. 7 provides the steps of an exemplary method through which a user, such as the host in the hereinbelow example, shares content through the disclosed real-time visualization module.

In an embodiment, the hereinbelow steps may performed by a presentation/conference host to share content with other users through the disclosed real-time visualization module. First, the host may download the video conference module 748. Next, the host may download the herein disclosed real-time visualization module 749. Upon downloading the real-time visualization module, the host may utilize an API, such as API 220 of FIG. 2, to upload documents to be shared to the real-time visualization module database 750. Then the host may initiate a video conference call via VCM and connect with the participants 751, such as participant 212 of FIG. 2. Once the participants have been connected, the host may click on the real-time visualization module icon, such as icon 401 of FIG. 4 to access a drop-down menu, such as drop-down menu 402 of FIG. 4, populated with the previously uploaded files, and choose which file(s) to share 752a. These files may include text documents, pictures, etc., but for the present embodiment, the host may select a 3D model, which upon selection, will appear on the host's screen and the screens of the participants within the VCM 752b. The host may then manipulate the 3D model, and these manipulations may be made visible to each participant 753. At this point, based on the needs of the presentation, the host may decide if the presentation requires a participant to manipulate the 3D model 754. If yes, the host may then elect to allow a chosen participant to manipulate the 3D model, 755a wherein the chosen user's manipulations would be reflected on other participant's screens 755b. If no, the host maintains control of the model 756 and may continue to control its manipulations.

One notable technical benefit of uploading shareable content to the real-time visualization module database is that said content may be accessed more rapidly and reliably than if the content were being actively shared from the host's desktop. When sharing from a host's desktop, said shareable content has to be actively shared between participant and host, effectively making the quality of the shared content reliant on the host's connection. This may cause the host's signal to lag, or have an increased latency, which would reduce the quality of the presented subject matter. By having the shared content already uploaded directly to user accessible database, the content (files) may be shared quickly and easily without relying on the connection of the host, thus minimizing latency. Using this method, participants may also be allowed to manipulate documents and models from the server in real time, which would likely be bandwidth intensive for the host if the content was accessed actively from said host's computer, particularly if multiple participants are each accessing and independently manipulating the content. Additionally, by not sharing the host's computer screen, pop-ups and other activities occurring on the host's system may be hidden from participant's view, thus helping maintain the host's privacy.

It should be understood that the above process is merely a potential embodiment of disclosed host presentation procedure and many obvious variations to this process may be implemented. In an alternative embodiment, each participant may be provided with their own copy of the 3D model to manipulate, where each participant's manipulations do not influence those of others. (e.g., a first participant may spin the 3D model, which does not result in the 3D model automatically spinning for the second, third, etc. participants). If all needed documents are already uploaded into the database, the host will likely not need to do so again, and thus said step may be omitted for follow-up meetings that do not require newly uploaded content. Other process modifications including may also be implemented while remaining within the scope of the application.

While the hereinabove embodiments disclose that the herein disclosed real-time visualization module may run concurrently with a VCM, it should be understood that other embodiments may be possible. In one embodiment, the herein disclosed EdLore module may behave agnostically and be fully separated from, but usable concurrently with, a preexisting VCM. In an alternative embodiment the disclosed EdLore module may incorporate the structure of the VCM within itself, such that VCM is incorporated into the structure of the EdLore module. In another alternative embodiment, the EdLore module may be incorporated into an existing VCM, potentially acting like a plug-in that may be installed within and coordinated with the VCM. In yet another alternative embodiment, the EdLore module may utilize its own VCM, not a currently used VCM in the industry, in order to facilitate the sharing of documents, video feeds, models, etc. in real time. Further implementations of the disclosed EdLore module may also be implemented depending on the needs of the specific situation it is applied within.

It may be advantageous to set forth definitions of certain words and phrases used in this patent document. As used herein and throughout this disclosure, the term “computer” refers to any electronic device capable of communicating across a network. A computer may have a processor, a memory, an input, and an output, including a display. The memory stores applications, software, or logic. Examples of processors are computer processors (processing units), microprocessors, digital signal processors, controllers and microcontrollers, etc.

“Logic” as used herein and throughout this disclosure, refers to any information having the form of instruction signals and/or data that may be applied to direct the operation of a processor. Logic may be formed from signals stored in a device memory. Software is one example of such logic. Logic may be formed from combinations of software and hardware. On a network, logic may be programmed on a server, or a complex of servers. A particular logic unit is not limited to a single logical location on the network.

The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims.

If present, use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Throughout this description, the aspects, embodiments or examples shown should be considered as exemplars, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

If means-plus-function limitations are recited in the claims, the means are not intended to be limited to the means disclosed in this application for performing the recited function, but are intended to cover in scope any equivalent means, known now or later developed, for performing the recited function.

If any presented, the claims directed to a method and/or process should not be limited to the performance of their steps in the order written, and one skilled in the art can readily appreciate that the sequences may be varied and still remain within the spirit and scope of the present invention.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples. Hence, the scope of the invention is defined by the accompanying claims and their equivalents. Further, each and every claim is incorporated as further disclosure into the specification.

What is claimed is:

1. A method for real-time visualization in the context of a video conference, the method comprising the steps of:
providing a video conferencing module;
providing a real-time visualization module;
providing an application programming interface;
providing a database server for storing and processing content necessary to conduct the video conference;
allowing users to utilize the application programming interface to upload content to the database server;
allowing the users to utilize the application programming interface to share content stored on the database server with other users attending the video conference; and
configuring the real-time visualization module to coordinate with the database server to display through the video conferencing module the manipulations made to the content in real time.

2. The method for providing a real-time visualization module of claim 1, wherein the manipulations made to the content are performed by a host user.

3. The method for providing a real-time visualization module of claim 2, further comprising the step of allowing the host user to transfer manipulation control over the content to selected participant user.

4. The method for providing a real-time visualization module of claim 2, further comprising the step of allowing a participant user to independently manipulate the content without the content being influenced by the manipulations made by the host user.

5. The method for providing a real-time visualization module of claim 1, wherein the real-time visualization module is implemented agnostically to the video conferencing module.

6. The method for providing a real-time visualization module of claim 1, wherein the content is a 3D model, and the manipulations comprise of rotating, zooming, taking a cross section, and exploding the view of the 3D model.

7. A real-time visualization module comprising a database and a set of software components configured to:
enable the real-time visualization module to operate concurrently with a video conferencing module;
provide an application programming interface to a user that is configured to allow the user to upload and organize content to the database;
deliver the content from the database to the user in real-time, wherein the content is displayed by the video conferencing module; and
allow a server to display through the video conferencing module the manipulations made to the content in real-time.

8. The real-time visualization module of claim 7, wherein the real-time visualization module is a plug-in within the video conferencing module.

9. The real-time visualization module of claim 7, wherein the video conferencing module is incorporated within the real time visualization module.

10. The real-time visualization module of claim 7, wherein the real-time visualization module operates agnostically from the video conferencing module.

11. The real-time visualization module of claim 7, wherein the manipulations made to the content may be performed by a host user and viewed in real time by participant users.

12. The real-time visualization module of claim 11, wherein the set of software components are further configured to allow the host user to transfer manipulation control to a selected participant user, such that the selected participant user may manipulate the content and other participant users may see the manipulations made to the content displayed through the video conference module.

13. The real-time visualization module of claim 7, wherein the set of software components are further configured to allow the host to upload a live video feed from an external recording device to the database.
